(19) United States
(12) Patent Application Publication
(10) Pub. No.: US 2024/0327174 A1
(43) Pub. Date: Oct. 3, 2024

(54) MOBILE EQUIPMENT

(71) Applicant: Liebherr-Werk Ehingen GmbH, Ehingen/Donau (DE)

(72) Inventor: Philipp MANG, Ehingen (DE)

(21) Appl. No.: 18/620,450

(22) Filed: Mar. 28, 2024

(30) Foreign Application Priority Data
Mar. 30, 2023 (DE) 10 2023 108 090.3

(51) Int. Cl. B66C 23/36; B60T 8/17

(52) U.S. Cl. CPC B66C 23/36; B60T 8/1701

(57) ABSTRACT

The disclosure relates to a mobile equipment, in particular a mobile crane, comprising a mobile under-carriage with at least two wheel axles, an upper-carriage rotatably mounted on the under-carriage with an upper-carriage driver's cab in which at least one operating unit for operating a working function of the equipment is arranged, a steering system for steering at least one steerable wheel axle and a brake system with brake devices for braking at least one wheel axle. According to the disclosure, the brake system comprises a brake valve arranged in the under-carriage for setting a brake pressure for the brake devices, which is electrically connected to the at least one operating unit of the upper-carriage driver's cab and can be controlled via the latter for braking the under-carriage.

### CROSS REFERENCE TO RELATED APPLICATION

The present application claims priority to German Patent Application No. 10 2023 108 090.3 filed on Mar. 30, 2023. The entire contents of the above-listed application are hereby incorporated by reference for all purposes.

### TECHNICAL FIELD

The present disclosure relates to a mobile equipment, in particular a mobile crane.

### BACKGROUND

Numerous machines with a movable under-carriage and a rotatably mounted upper-carriage are known from the prior art, for example hydraulic excavators, civil engineering equipment such as vibratory pile drivers or rotary drilling rigs, duty cycle crawler cranes or mobile cranes. The under-carriages of such equipment typically have either a crawler chassis or a wheeled chassis with several wheel axles. An upper-carriage driver's cab is often arranged on the upper-carriage, from which the operator or driver of the equipment can control work functions such as pivoting a boom or lowering a hoist cable via special control units, while movement of the entire equipment or the under-carriage is controlled via a separate driver's cab on the under-carriage.

### SUMMARY

Wheeled under-carriage equipment also typically include a hydraulic or pneumatic brake system with brake devices, which are usually designed as disk brakes for braking one or more wheel axles. The brake devices can be actuated and controlled via a brake pedal in the under-carriage driver's cab. The equipment can be moved or accelerated via an accelerator pedal. Steering is usually carried out via a steering wheel located in the under-carriage driver's cab, wherein it is known to additionally equip the equipment with a hydraulic steering assistance system that supports the mechanical steering via corresponding hydraulic steering cylinders.

If the equipment is also to be moved and braked from the upper-carriage driver's cab, corresponding accelerator and brake pedals are also provided in the upper-carriage driver's cab. In this case, it is necessary to route the pneumatic or hydraulic lines of the brake system from the under-carriage into the upper-carriage, connect them to the pedal in the upper-carriage driver's cab and then route them back into the under-carriage. The connection between the upper-carriage and under-carriage is made via pneumatic or hydraulic rotary unions. However, these are of complex design and require maintenance. Furthermore, such solutions require the installation of additional components such as accelerator and brake pedals in the upper-carriage driver's cab.

Therefore, the object underlying the disclosure is to provide a generic mobile equipment which can be controlled and braked from the upper-carriage driver's cab and which has a less complicated design of the brake system. In particular, a complicated rotary feed-through of pneumatic or hydraulic brake lines is to be omitted.

According to the disclosure, this object is achieved by an equipment having the features described herein. Advantageous embodiments of the disclosure are specified in the following description.

Accordingly, on the one hand, a mobile equipment is proposed, which may in particular be a mobile crane. The equipment comprises a mobile under-carriage and an upper-carriage rotatably mounted on the under-carriage, wherein the under-carriage comprises a chassis with at least two wheel axles, of which at least one wheel axle is steerable. The equipment further comprises a steering system for steering at least one steerable wheel axle (and thus the under-carriage) and a brake system with brake devices for braking at least one wheel axle (and thus for braking the under-carriage).

However, according to the disclosure, the proposed mobile equipment can also be a crane with crawler chassis. In the crawler chassis, the steering movement is formed by the differential speed between the left and right crawler chassis. In contrast to the mobile crane, an additional steering motor is not necessary. The crawler chassis is accelerated and decelerated by a drive unit, such as a hydraulic motor. To decelerate the crawler chassis, the acceleration is reduced, and the vehicle decelerates using its own static friction. This is in contrast to wheel-driven vehicles, such as mobile cranes, where a service brake is used for braking. The crane with crawler chassis can still be accelerated and braked/decelerated using its own master switch. In a de-energized state, a crane on a crawler chassis does not roll away due to the high friction. Therefore, unlike a wheel-driven mobile crane, no parking brake is required. In principle, a crane with crawler chassis can also be operated with a remote control.

Preferably, the under-carriage comprises an under-carriage driver's cab. A brake pedal for braking the under-carriage, an accelerator pedal for accelerating or controlling the speed of the under-carriage and/or a steering wheel for steering the under-carriage can be arranged therein.

According to the disclosure, the brake system comprises a brake valve arranged in the under-carriage for adjusting or setting a brake pressure for the brake devices. The brake valve is electrically connected to the at least one control unit of the upper-carriage driver's cab and can be controlled via the at least one control unit to brake the under-carriage. In other words, the under-carriage can be braked from the upper-carriage driver's cab by actuating the at least one control unit.

Due to the electrical connection between the brake valve and the at least one control unit, there is no need for a rotary feed-through for the brake fluid (e.g. air or hydraulic oil) from the under-carriage to the upper-carriage. In addition, there is no need to install a brake pedal in the upper-carriage driver's cab, as the control unit already present in the upper-carriage driver's cab for operating the working function(s) of the equipment is used to brake the under-carriage. The latter therefore performs a dual function in particular: moving and braking the entire equipment as well as operating one or more work functions (e.g. raising/lowering a boom).

Preferably, the brake function can be activated and deactivated by the operator from the upper-carriage driver's cab (upper-carriage brake mode; this can in particular also include acceleration and/or steering via the at least one control unit), in particular by actuating a switching element in the upper-carriage driver's cab. The switching element can, for example, be a switch or button or an element displayed on a touch pad. When the upper-carriage brake mode is deactivated, the at least one control unit is used to control at least one working function of the equipment (e.g. raising/lowering the boom, retracting/extending the boom, etc.). When the upper-carriage brake mode is activated, the under-carriage can be braked and preferably also accelerated via the at least one control unit (this refers to acceleration in the sense of “pressing the accelerator” and not a negative acceleration in the sense of braking) and/or steered.

In one possible embodiment, there is no accelerator pedal and/or brake pedal provided in the upper-carriage driver's cab. Instead, the acceleration and/or braking of the under-carriage, which was previously performed via the accelerator pedal and/or brake pedal, can be performed exclusively via the at least one control unit of the upper-carriage driver's cab. This means that fewer components need to be installed in the upper-carriage driver's cab.

In another possible embodiment, the brake system does not include a hydraulic or pneumatic connection between the under-carriage and upper-carriage. This means that, in particular, no rotary feed-through for hydraulic or pneumatic fluids used for braking is required between the under-carriage and upper-carriage, which simplifies the design. Preferably, all brake lines are therefore located in the under-carriage, with control from the upper-carriage driver's cab being effected electrically. Irrespective of the absence of hydraulic or pneumatic connections between the under-carriage and upper-carriage for braking, connections for other functions, e.g. one or more hydraulic connections between the under-carriage and upper-carriage for one or more working functions (operating hydraulics) may be present.

In a further possible embodiment, the at least one control unit is a master switch that is fixedly installed in the upper-carriage driver's cab. The master switch is preferably designed as a joystick or comprises a joystick. The master switch can be programmed so that deflection or actuation of the joystick in a certain direction (e.g. away from the operator, i.e. forwards or towards the operator, i.e. backwards) results in braking.

In a further possible embodiment, two master switches are provided in the upper-carriage driver's cab, wherein a speed and/or acceleration of the under-carriage can be controlled by actuating a first master switch (which was previously achieved by means of the accelerator pedal) and braking of the under-carriage can be controlled by actuating a second master switch (which was previously achieved by means of the brake pedal).

Preferably, the under-carriage can also be steered via the master switches. A preferred assignment is one in which braking is performed with one master switch and speed control or acceleration with the other master switch by actuation in the Y direction (away from or towards the operator). Steering, for example, can be performed with one of the two master switches by actuating it in the X direction (i.e. perpendicular to the Y direction or to the right and left).

In an optional embodiment, several steering programs can be provided (e.g. road driving and/or all-wheel steering and/or crab steering and/or steering without extension and/or independent steering). If necessary, these can be divided between the two master switches (i.e. one or more of the steering programs by actuating one master switch in the X direction and the other steering programs by actuating the other master switch in the X direction).

In a further possible embodiment, it is provided that the under-carriage comprises a drive motor which is electrically connected to the at least one control unit and can be controlled via the latter to control the travel speed of the under-carriage. The drive motor may be a diesel engine, although the use of one or more electric motors alone or in combination with an internal combustion engine (hybrid drive) is also conceivable. The at least one control unit thus also assumes the function of the previously installed accelerator pedal.

In a further possible embodiment, it is provided that the steering system comprises a steering drive arranged in the under-carriage, which is electrically connected to the at least one control unit and can be activated via this to control the steering of at least one steerable wheel axle. This means that the equipment or the under-carriage can not only be braked but also steered from the upper-carriage driver's cab. The steering drive can be a steering motor.

Preferably, a manual steering device such as a steering wheel is located in an under-carriage driver's cab, which in particular is mechanically connected to one or more steerable wheel axles and allows manual steering. This can, for example, be supported by a hydraulic steering assistance system (power steering).

It should be noted at this point that the statement used here in several places that the steering drive, the drive motor, the brake valve or other components are “electrically connected to the at least one control unit” does not rule out the possibility that one or more electronic components are interposed, for example a control unit.

In a further possible embodiment, it is provided that the brake valve is electrically connected to a control unit, which in turn is electrically connected to at least one receiving unit. The receiving unit is configured to wirelessly receive control signals from a mobile control unit for remotely actuating the brake valve. The control unit receives these signals from the receiving unit and actuates the brake valve according to the control commands. This means that the mobile equipment can also be braked via remote control.

The integration of control or braking via remote control is particularly simple using the solution according to the disclosure, since the brake system is controlled electrically from the upper-carriage driver's cab anyway and therefore only corresponding receiving units have to be provided in the equipment in order to be able to receive the radio signals from a mobile control unit.

In a further possible embodiment, it is provided that the mobile equipment can not only be braked, but also steered and/or accelerated via remote control (or the speed can be controlled, i.e. maintained or changed, as when using a classic accelerator pedal). For this purpose, the control unit is electrically connected to a steering drive arranged in the under-carriage and/or to a drive motor arranged in the under-carriage and is configured to obtain wirelessly transmitted control signals for controlling the drive motor and/or the steering drive via the at least one receiving unit. The respective control signals can be received either via a single receiving unit or via multiple receiving units.

In another possible embodiment, a drive motor arranged in the under-carriage is provided to supply power for a working function of the equipment. The drive motor can be the traction motor of the under-carriage or a separate working motor. It can be an electric motor or an internal combustion engine such as a diesel engine. Furthermore, the equipment comprises a control unit which is configured to automatically adjust a rotational speed of the drive motor to a power requested by at least one actuator of the equipment to perform a work function. This can take place within the framework of a so-called ECO mode. The ECO mode can, for example, be designed to perform an automatic speed increase when the at least one operating unit of the upper-carriage driver's cab is actuated to achieve a working movement (e.g. crane movement in the upper-carriage).

In another possible embodiment, a display unit is provided in the upper-carriage driver's cab, on which at least one parameter can be displayed, in particular graphically illustrated, which relates to a current braking process and/or a current acceleration process of the under-carriage. The display unit can comprise a display and/or a touchscreen. The display unit can be designed to display the deflection of one or more operating elements (e.g. one or more master switches), for example in the form of a bar graph, although other types of display are of course also possible. The displayed deflection can represent a braking force and or speed and or acceleration and or a steering angle.

In a further possible embodiment, it is provided that a speed of the under-carriage can be controlled via the at least one operating unit (in the context in which this can usually be done via an accelerator pedal) and/or the under-carriage can be steered, wherein a control unit connected to the operating unit is configured to adapt the operating inputs required to achieve a specific speed adjustment and/or steering effect to a current position of the equipment, in particular a current angle of rotation of the upper-carriage relative to the under-carriage. The latter can mean, for example, that a rotation of the upper-carriage beyond 90° in relation to a forward orientation results in the assignment of the at least one operating unit being reversed. The position of the upper-carriage is preferably detected by one or more sensors and made available to a control unit, which makes the corresponding adjustments to the programming or assignment of the control unit. Thus, in particular, the change over the 90° limit is also identified.

In one exemplary embodiment, a master switch is provided as an operating unit for steering the under-carriage, wherein the master switch assignment has the following properties: if the upper-carriage points towards the front of the under-carriage, a deflection of the master switch to the right causes the equipment to move to the right from the driver's perspective; if the upper-carriage points towards the rear of the under-carriage (this corresponds in particular to a rotation of the upper-carriage of more than) 90°, a deflection of the master switch to the right again causes the equipment to move to the right from the driver's perspective (i.e. to the left from the perspective of a person in the under-carriage driver's cab). To implement this technically, the master switch assignment must be turned. This takes place automatically by the software or the control unit. The switchover for the “acceleration” commands of the same or another master switch can be carried out in the same way.

Preferably, the braking function remains unchanged, i.e. the relevant assignment preferably does not change. So if braking is controlled by deflecting the or a master switch in a certain direction (preferably the positive Y direction, i.e. away from the operator), this deflection direction persists-independent of the angle of rotation of the upper-carriage.

Adjusting the assignment of the at least one control unit in this way, depending on the position of the upper-carriage, enables intuitive operation of the equipment.

In a further possible embodiment, it is provided that the under-carriage can be both braked and accelerated via a single control unit, in particular a master switch (so-called “one pedal driving”). In the case of a master switch, this can be deflected from a holding position of the equipment, which corresponds to a zero position of the master switch, in the Y direction (away from/towards the operator), wherein the acceleration is the greater the further the master switch is deflected. When the deflection is reduced, the acceleration is reduced again. The zero position is preferably not exceeded. Alternatively, it would also be conceivable to accelerate from the zero position forwards (positive Y direction) and to brake from the zero position backwards (negative Y direction).

Alternatively, a first master switch could be provided for braking and a second master switch for accelerating.

In a further possible embodiment, it is provided that a gear for forward travel or reverse travel of the under-carriage can be selected by actuating an operating unit, in particular a master switch. In other words, the gear (or one of several gears) for forward travel and the gear for reverse travel (i.e. the reverse gear) can be selected by means of one of the at least one operating units. This eliminates the need for a separate travel selector switch.

For example, two master switches can be provided as control units in the upper-carriage driver's cab and the forward or reverse gear can be engaged automatically in a defined sequence of actuation steps. This means that accidental actuation can be ruled out. For example, the following sequence of steps to be performed by the operator would be conceivable:
1. Activation of the service brake.
2. Activation of acceleration when the service brake is active. This causes the control unit to release the parking brake. The service brake holds the equipment safely at a standstill. The control unit also engages the corresponding gear. When the corresponding master switch is deflected in the forward direction, the control unit engages forward gear (D) and when the master switch is deflected in the reverse direction, the control unit engages reverse gear (R).
3. The operator then releases the service brake and the equipment accelerates in the desired direction.

### BRIEF DESCRIPTION OF THE FIGURES

Further features, details and advantages of the disclosure can be seen from the exemplary embodiments explained below with reference to the Figures. The Figures show:

FIG. 1: A side view of an exemplary embodiment of the equipment according to the disclosure;

FIG. 2: A schematic illustration of the drive train of the mobile crane;

FIG. 3: An exemplary embodiment for a display of the current deflection of an operating unit for controlling and braking the equipment in “One Pedal Driving” mode;

FIG. 4: An exemplary embodiment of an arrangement of operating units in the upper-carriage driver's cab;

FIGS. 5-8: Exemplary embodiments of displays on a display unit installed in the upper-carriage driver's cab; and

FIG. 9: an overview of master switch assignments with different upper-carriage positions.

### DETAILED DESCRIPTION

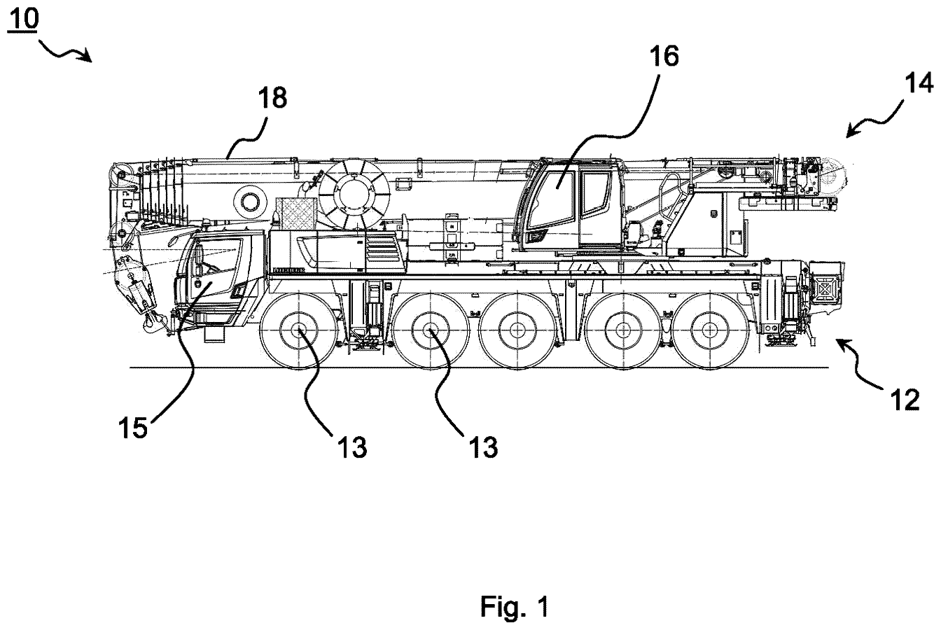

FIG. 1 shows a side view of an exemplary embodiment of the mobile equipment according to the disclosure in the form of a mobile crane 10. The mobile crane 10 has an under-carriage 12 with a wheeled under-carriage and an upper-carriage 14 mounted on the under-carriage 12 so as to rotate about a vertical axis of rotation via a slewing gear. The upper-carriage 14 comprises a telescopic boom 18 mounted to luff about a horizontal axis and an upper-carriage driver's cab 16. An under-carriage driver's cab 15 is located in the front area of the under-carriage 12.

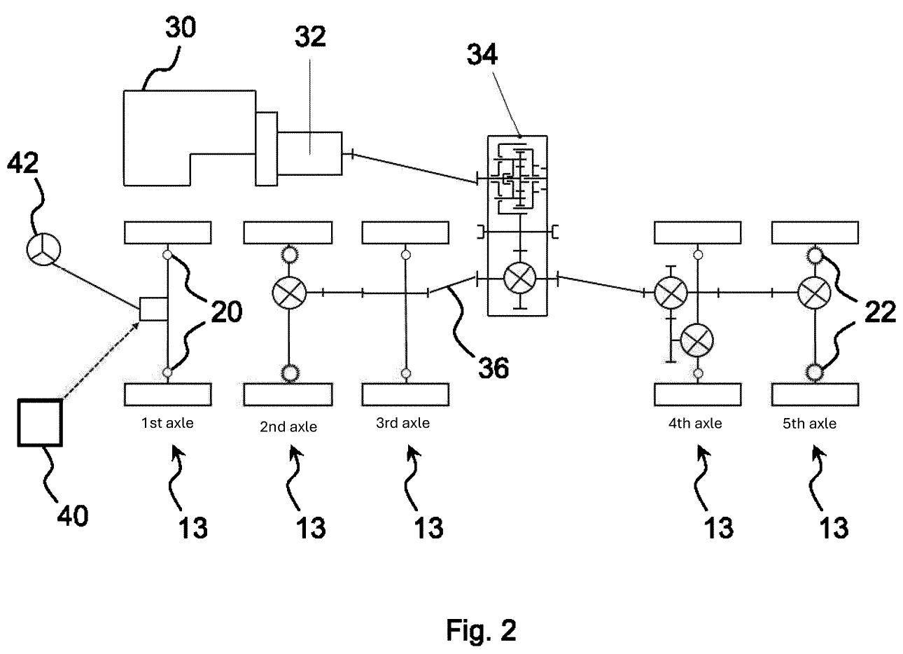

FIG. 2 shows the drive train of the mobile crane 10 in schematic form. In this exemplary embodiment, the wheeled under-carriage of the mobile crane 10 comprises five wheel axles 13. A drive motor 30, which may be a diesel engine, is located in the under-carriage 12. The drive motor 30 provides the necessary drive power and serves as a traction motor for driving the under-carriage 12. The drive motor 30 is coupled to a transfer case 34 via a transmission 32. The drive power is transmitted through the transfer case 34 to the wheel axles 13, which are driven by it. Starting from the transfer case 34, a drive shaft 36 extends to the driven wheel axles 13. In the exemplary embodiment shown here, these are the second to fifth wheel axles 13.

The transmission 32 can be an automatic transmission. This is used to set the direction of travel and the gear. In one embodiment, “D” stands for “Drive” or “forwards”, “R” for “Reverse” or “backwards” and “N” for “Neutral”. These symbols can, for example, be displayed on a travel selector switch in the upper-carriage driver's cab 16, allowing the desired gear to be set.

The first, third and fourth wheel axles 13 (counted from left to right in FIG. 2) are each equipped with brake devices 20 in the form of disk brakes. The second and fifth wheel axles 15 have brake units 22 in the form of a combination of disk brakes and parking brakes. In the following, all disk brakes (i.e. also those of the wheel axles 13 provided with the brake units 22) are denoted with reference character 20. In this exemplary embodiment, each wheel axle 13 is therefore provided with a disk brake 20, the so-called service brake; selected axles 13 are provided with a disk brake/service brake 20 and a parking brake (also referred to as a handbrake in a car). The disk brakes 20 are part of the brake system of the mobile crane 10 and are used to brake the under-carriage 12 or the entire mobile crane 10.

In order to move the mobile crane 10 on public roads (road operation), it is controlled via the under-carriage driver's cab 15, which has a corresponding accelerator pedal for accelerating (or controlling the speed) of the mobile crane 10 and a brake pedal for braking the mobile crane 10, as is known from the prior art. In addition, a steering wheel 42, shown schematically in FIG. 2, is located in the under-carriage driver's cab 15 for steering the under-carriage 12 during travel. In the exemplary embodiment shown here, the steering wheel 42 is mechanically coupled to the first wheel axle 13, which is also referred to as the front axle. Preferably, the remaining wheel axles 13 can also be steered, wherein these follow the front axle according to a defined steering program (see below) and are also referred to as rear axles.

In road operation, the disk brakes 20 are actuated by the brake pedal in the under-carriage driver's cab 15. The control fluid can be air (pneumatic) or oil (hydraulic). The parking brake is opened or closed by means of an actuating device (e.g. a pneumatic actuating device). Actuation is effected from the under-carriage driver's cab 15 via a corresponding control element.

The mobile crane 10 can have several steering programs that can be selected by the driver or operator as required. Possible steering programs are listed hereinbelow, one or more of which programs can be implemented in any combination in the mobile crane 10.

In a first steering program, the rear axles (FIG. 2: axles 2-5) automatically align themselves with the front axle (FIG. 2: axle 1). The steering angles of the rear axles are optimized for road travel.

In a second steering program, the rear axles automatically align themselves with the front axle. The steering angles of the rear axles are optimized for a minimum turning radius of the mobile crane 10.

In a third steering program, the rear axles automatically align themselves with the front axle. The steering angles of the rear axles are designed so that all wheel axles 13 (i.e. front and rear axles) point in the same direction or have the same (or a very similar) steering angle, and the under-carriage 12 moves in this direction in so-called “crab steering”.

In a fourth steering program, the rear axles automatically align themselves with the front axle. The steering angles of the rear axles are designed in such a way that the rear of the mobile crane 10 shears out minimally. As a result, the steering angles on the rear wheel axles 13 are greatly reduced.

In a fifth steering program, the rear axles are not aligned with the front axle. The steering angles of the rear axles can be preset by the operator. Compared to the steering programs mentioned above, this steering program requires an additional setting device.

With known mobile cranes, the vehicle could sometimes also be controlled and braked from the upper-carriage driver's cab, wherein corresponding accelerator and brake pedals had to be installed in the upper-carriage driver's cab and the brake medium (air/oil) also had to be fed from the under-carriage into the upper-carriage, to the pedals and back into the under-carriage via corresponding rotary unions.

In the mobile crane 10 according to the disclosure, it is possible to control the under-carriage 12 from the upper-carriage driver's cab 16, i.e. to steer (function of a steering wheel), accelerate (function of an accelerator pedal) and decelerate (function of a brake pedal, without the need to install pedals or a steering wheel in the upper-carriage driver's cab 16 or to provide rotary unions for the brake medium. For this purpose, the corresponding valves and actuators can be controlled electrically from the upper-carriage driver's cab 16 via the control units already installed, which are normally used to control the upper-carriage or crane functions (e.g. luffing the boom 18 up and down, rotating the upper-carriage 14, telescoping the boom 18 in and out, actuating the hoist cable, etc.).

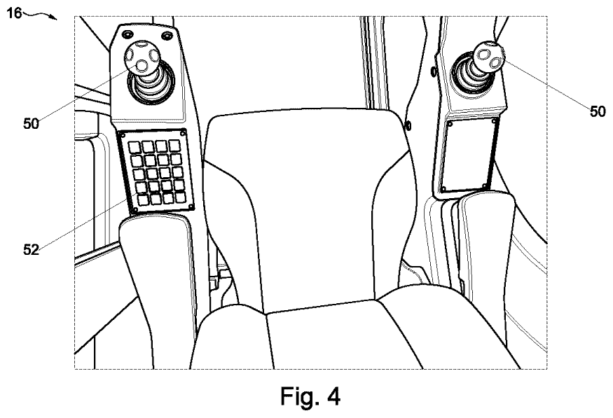

According to one exemplary embodiment, two master switches 50 can be permanently installed in the upper-carriage driver's cab 16 for this purpose (these are often installed in the upper-carriage driver's cab in mobile cranes to control the crane movements), which are also used to accelerate, steer and brake the mobile crane 10 (more precisely, the under-carriage 12). A possible exemplary embodiment is shown in FIG. 4.

For this purpose, the master switches 50 are electrically connected to an electrically actuated brake valve installed in the under-carriage 12, the drive motor 30 and a steering drive or steering motor 40 (see FIG. 2) connected to the front axle. Therefore, only corresponding electrical connections (e.g. a bus system) must be provided between the under-carriage 12 and the upper-carriage 14.

In this embodiment, the mobile crane 10 can therefore be moved completely with the master switches 50, which are permanently installed in the upper-carriage driver's cab 16 (e.g. one master switch 50 on the right and one master switch 50 on the left). The brake pressure is determined by the master switch deflection and controlled via the electrically operated brake valve now installed in the under-carriage. The brake valve previously installed in the brake pedal of the upper-carriage 14 (or coupled to it) is now no longer actuated by foot force, but electrically and relocated to the under-carriage 12.

According to an exemplary embodiment, one of the two master switches 50 (e.g. the right master switch 50) replaces the brake pedal, wherein braking is performed by actuation or deflection of the master switch 50 in the Y-direction (in this case, the direction towards or away from the operator). The other (e.g. left-hand) master switch 50 replaces the accelerator pedal in the upper-carriage 14, wherein here, too, the master switch 50 is actuated or deflected in the Y-direction. Optionally, the master switch assignment can also be rotated or reversed if desired. In this case, the right master switch 50 replaces the accelerator pedal and the left master switch 50 replaces the brake pedal. The assignment can be changed or adjusted via a corresponding input unit in the upper-carriage driver's cab 16 in order to be able to adapt the assignment easily and flexibly to the needs of the operator.

The under-carriage 12 or the wheel axles 13 can be steered by moving or deflecting one of the two master switches 50 in the X direction (in the present case, this is the direction perpendicular to the Y direction, i.e. to the right and left as seen from the operator). It may be provided that several steering programs (e.g. one or more of the steering programs listed above) are divided between the two master switches 50, for example in such a way that the steering is performed via the right master switch 50 for one or more steering programs and via both master switches 50 for the remaining steering programs. Here too, the assignment can be flexibly adjustable or configurable by the operator. The steering program can be selected by means of an input unit (e.g. buttons, touchpad or the like). Each steering program can be assigned to a separate button on an operating and control display (BSA) installed in the upper-carriage driver's cab 16.

With an automatic transmission 32, the direction of travel can be selected via a travel selector switch with the assignment D-N-R in the upper-carriage driver's cab. Gear “R” and gear “D” refer to the direction of the mobile crane 10. To engage a gear, it is preferable to press a button on the travel selector switch in the upper-carriage driver's cab 16 and simultaneously actuate the service brake using the master switch 50, which replaces the brake pedal. The master switch 50, which replaces the accelerator pedal, accelerates the mobile crane 10 when deflected in the Y direction (preferably in the positive Y direction, i.e. away from the operator) when gear “D” is engaged and when deflected in the negative Y direction (i.e. towards the operator) when gear “R” is engaged.

Preferably, a maximum speed is defined for the movement of the mobile crane 10, up to which the mobile crane 10 can accelerate. The maximum speed when moving from the upper-carriage driver's cab 16 is preferably restricted. The mobile crane 10 is accelerated and decelerated via the aforementioned master switch 50. With this concept, the speed of the mobile crane 10 is influenced in particular in such a way that the mobile crane 10 can be both accelerated and braked by the driver with a single master switch 50 (so-called “one pedal driving”).

By deflecting the master switch 50, which replaces the brake pedal, in the Y direction, the mobile crane 10 can also be brought to a standstill (independently of the master switch 50, which replaces the accelerator pedal). By actuating the master switch 50, which replaces the brake pedal, and simultaneously actuating the travel selector switch D-N-R, the parking brake preferably opens automatically and a travel direction is selected.

Alternatively, it can be provided that the mobile crane 10 brakes and comes to a standstill when the mobile crane 10 is in motion and all master switches 50 are moved to the zero position (in particular from the positive Y deflection to the zero position from the crane operator's point of view during forward travel, and from the negative Y deflection to the zero position from the crane operator's point of view during reverse travel) or are in this position. The braking force is preferably specified by software in order to brake the mobile crane 10 in a defined time and bring it to a standstill.

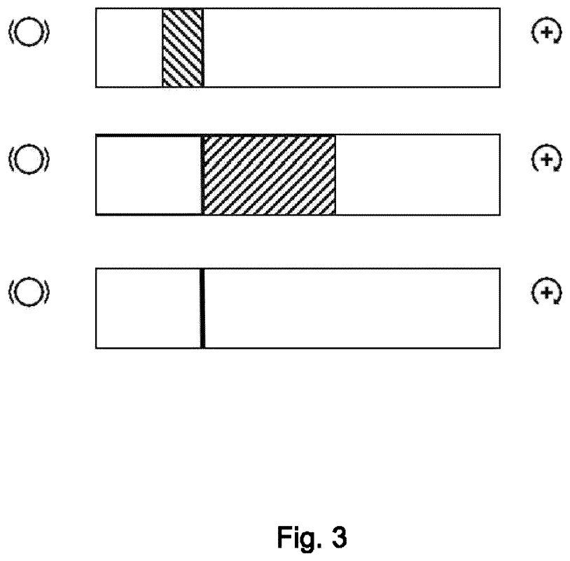

FIG. 3 shows an exemplary embodiment of a possible display of the deflection of the master switch 50 in the case of using a single master switch 50 for accelerating/braking (One Pedal Driving), which is displayed on a display unit 60 (e.g. display or touch screen) in the upper-carriage driver's cab 16. Preferably, the deflection display is visualized on said BSA. A preferred representation is in the form of bars whose length represents the deflection of the master switch 50, which specifies or controls the acceleration, in a particular direction. Several bars can be superimposed, e.g. a bar representing the maximum deflection, which is superimposed by a dynamically generated bar (hatched in FIG. 3) indicating the current deflection. Alternatively or additionally, corresponding numerical values for the deflection and/or the actual values (e.g. braking force, acceleration, speed) can be displayed.

In the exemplary embodiment shown in FIG. 3, which is merely exemplary for a large number of possible forms of illustration, a bar display relating to the current acceleration is shown in three states. If the mobile crane 10 is braked using the master switch 50 (One Pedal Driving), the analog deflection indicator deflects in the direction of “braking” (upper bar display: deflection of the hatched bar to the left); if it is accelerating, the deflection indicator deflects in the direction of “accelerating” (middle bar display: deflection of the hatched bar to the right). If neither braking nor accelerating is effected, the display remains in a central position (lower bar display). The deflection display allows the operator to drive the mobile crane 10 in a fuel-saving manner, for example by allowing it to coast.

When the service brake is actuated (which is particularly the case when all master switches 50 are in the zero position), it is more difficult to steer when stationary, as the axles 13 are mechanically braced with the service brake actuated. It should therefore also be mentioned that the deflection indicator helps the operator to slowly release the braking force using the master switch 50 (One Pedal Driving) when steering at a standstill.

In a preferred embodiment, the master switch assignment changes with a change in the rotation angle position of the upper-carriage 14 relative to the under-carriage 12, so that the operator is always provided with intuitive operation. For example, if the upper-carriage 14 is rotated towards the front, the master switch assignment can be selected in such a way that a deflection to the right results in the mobile crane 10 (or under-carriage 12) being steered to the right. If the mobile crane 10 is to be steered to the left, the master switch 50 must be moved to the left.

If it is statically possible, the mobile crane 10 can be moved with any angular offset from upper-carriage 14 to under-carriage 12. If the upper-carriage 14 is exactly perpendicular (90° offset) to the under-carriage 12, it can be provided in one exemplary embodiment that the previous master switch assignment is maintained, while if the upper-carriage 14 rotates further (i.e. If the upper-carriage 14 continues to rotate by) 1° with both master switches 50 in the zero position, the master switch assignment is switched over (e.g. the master switch assignment changes in such a way that a master switch deflection to the right causes the mobile crane 10 or the under-carriage 12 to steer to the left).

In a further exemplary embodiment, the travel selector switch D-N-R is omitted. One of the master switches 50 (e.g. the master switch 50 on the left) engages the gear for forward travel in the positive Y+ direction (from the viewpoint of the upper-carriage driver's cab 16, which can rotate relative to the under-carriage 12) and the gear for reverse travel in the negative Y direction (again from the viewpoint of the position of the upper-carriage driver's cab 16). To do this, however, the service brake in particular must be applied (e.g. master switch 50 on the right in the positive Y direction). For reversing (direct change from forward to reverse), it is not necessary to actuate the service brake. If the gear is determined or engaged via the deflection of master switch 50, the parking brake opens when master switch 50 is deflected.

In one embodiment, an emergency stop button can be provided in the upper-carriage driver's cab 16. Said button now also acts on the vehicle during movement. In particular, pressing the emergency stop button causes the drive motor 30 to stop and the parking brake to close so that the mobile crane 10 in motion comes to a standstill.

Preferably, the mobile crane 10 has an ECO mode, which automatically increases the rotational speed of the drive motor 30 when the master switch 50 is deflected to achieve a crane movement in the upper-carriage 14. The ECO mode can preferably be activated/deactivated in the upper-carriage driver's cab 16 using a special button. In known mobile cranes which have such an ECO mode, the crane operator can increase the speed using the accelerator pedal installed in the upper-carriage driver's cab. In the solution according to the disclosure, all accelerator and brake pedals in the upper-carriage driver's cab 16 are omitted. The ECO mode automatically adjusts the speed for crane operation. The mobile crane 10 therefore automatically adjusts the rotational speed of the drive motor 30 optimally for the required or demanded performance of the crane actuators.

In a preferred embodiment, the mobile crane 10 can also be controlled (i.e. steered, accelerated and braked) by radio or remote control. Instead of generating the control commands via the master switches 50 in the upper-carriage driver's cab 16, this is done via a mobile operating unit (this can also have two joysticks or master switches 50, for example, which have a corresponding assignment as described above). For this purpose, the mobile crane 10 has a corresponding receiving unit that receives the radio signals. Further control of the brake valve, the drive motor 30 and the steering drive 40 is carried out in particular as described above.

FIG. 4 shows an exemplary embodiment of an arrangement of operating units in the upper-carriage driver's cab 16 of a mobile crane 10. The driver's seat can be seen in the middle and two master switches 50 to the side as operating units. In the illustration, the Y direction is the up/down direction, while the X direction corresponds to the left/right direction. A travel selector switch 52 (D-N-R) for selecting forward or reverse gear can be seen below the left master switch 50.

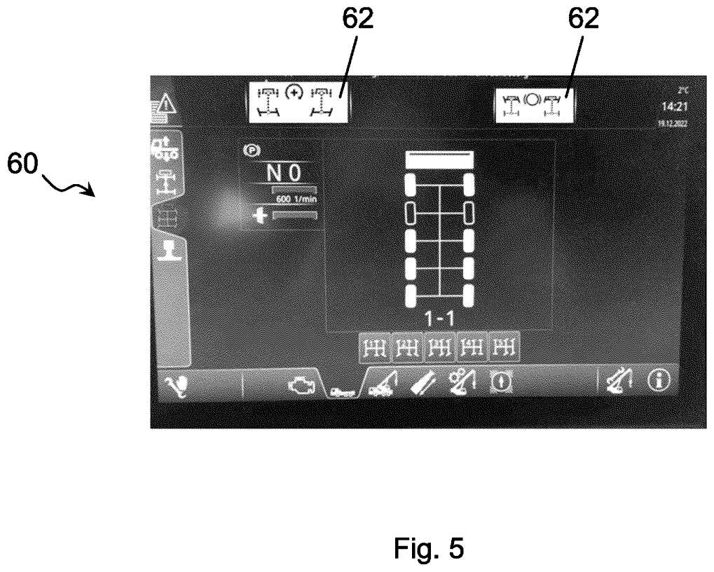

FIG. 5 shows a possible display on a display unit 60 installed in the upper-carriage driver's cab 16 of a mobile crane 10, which is preferably the BSA described above. This can be arranged in the area of a master switch 50 (in the exemplary embodiment of FIG. 4, for example, above the right-hand master switch 50). In the upper area of the display there are two display panels 62, which show the current assignment of the master switches 50. In the exemplary embodiment shown here, the right-hand master switch 50 is used to brake when the vehicle is deflected in the positive Y direction (see circle symbol with side brackets in the right-hand display panel 62) and to steer the front axle(s). The left master switch 50 is used to accelerate by deflection in the Y direction (see the plus sign surrounded by a curved arrow in the left-hand display panel 62) and to steer the rear axle(s) by lateral deflection (in the X direction). In the center is a schematic representation of the under-carriage chassis with the different wheel axles 13, with the vehicle frame being indicated as a central line connecting the wheel axles 13.

It should be noted at this point that the exact configuration and arrangement of the travel selector switch 52 and the display unit 60 (or the symbols and display panels displayed thereon) in the upper-carriage driver's cab 16 is not further relevant to the present disclosure. The embodiments shown and discussed herein each constitute only one of a plurality of possible examples.

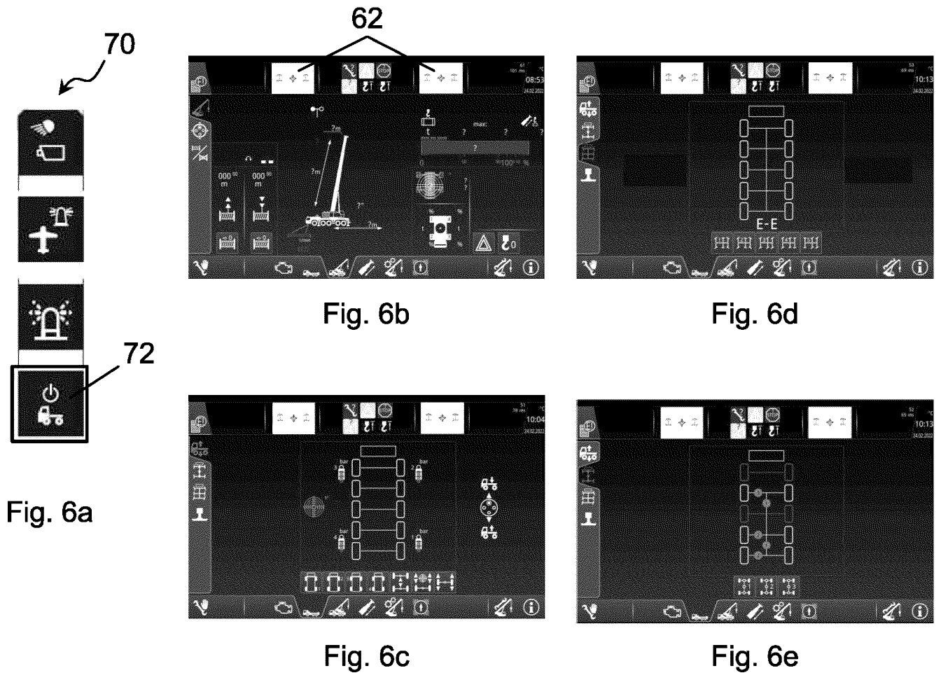

FIGS. 6b to 8 show further examples of displays on the display unit 60 of a mobile crane 10.

FIG. 6a shows a switch unit 70, which can be located, for example, on the display unit 60 (if this has a touch pad via which inputs can be made) or on a separate input unit (e.g. the travel selector switch 52). The lowest switch or button 72, bordered with a box for highlighting purposes, activates and deactivates driving from the upper-carriage driver's cab 16 (upper-carriage braking mode). Preferably, only on the basis of this button 72 is it possible to use the existing master switches 50 in the upper-carriage driver's cab 16 for braking/accelerating/steering the under-carriage 12. For steering, it switches the actuators to the master switches 50 and no longer to the actuators for performing the movement of the crane components.

FIGS. 6b-e show four different representations or displays on the display unit 60. The latter has a selection bar with tabs on the bottom edge and on the left edge. In the display of FIG. 6b, the “crane operation” tab is selected; in the displays of FIGS. 6c-e, the “under-carriage travel” tab is selected (tab at the bottom edge). The three displays in FIGS. 6c-e belong to different under-carriage functions (FIG. 6c: axle suspension, FIG. 6d: steering and FIG. 6c: differential lock). In all displays, there are display panels 62 at the top edge, which show the assignment of the two master switches 50 for driving operation.

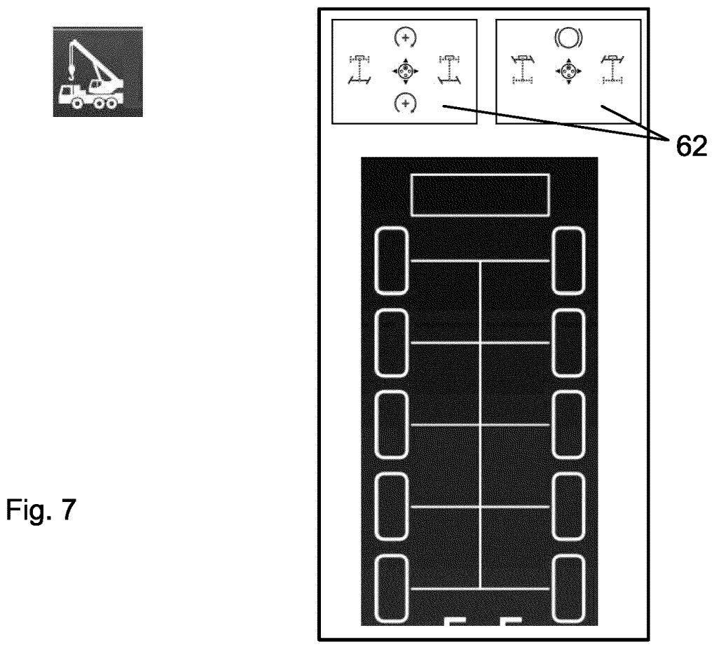

FIG. 7 shows enlarged details of the display in FIG. 6d. The operator or driver in the upper-carriage driver's cab 16 is looking towards the under-carriage driver's cab 15 (see symbol in the top left of FIG. 7). The two display panels 62 for visualizing the master switch assignment are also shown. In this exemplary embodiment, the steering program previously referred to as the “fifth steering program” is selected. Here, all wheel axles 13 of the under-carriage 12 are steered. It can be seen that the left master switch 50 (belonging to the left display panel 62) steers the front axle(s) and the right master switch 50 (belonging to the right display panel 62) steers the rear axle(s) of the under-carriage 12. There may be one or more front and/or rear axles. Furthermore, the brake symbol (circle in brackets) can be seen on the right-hand display panel 62 and the “speed-increasing symbol” (plus surrounded by arrow) on the left-hand display panel 62 in forward travel and in reverse travel. The master switch assignment preferably remains visible at all times.

The symbols of the mobile crane 10 and the steering of this exemplary embodiment shown in the display panels 62 must be explained. The display panels 62 show the front axles (right display panel 62) and the rear axles (left display panel 62), each with the wheels and the steering angle. The rectangular box in the large, central display of the chassis represents the under-carriage driver's cab 15 and defines the front of the under-carriage 12.

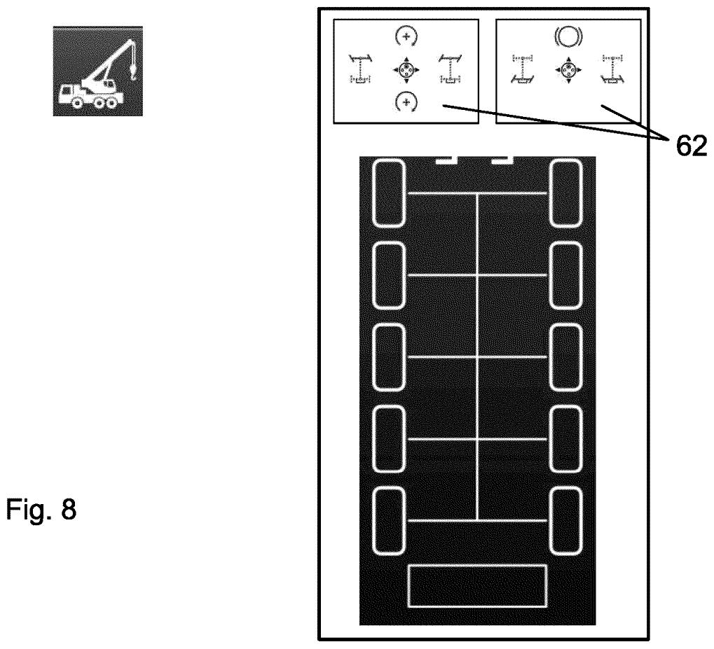

FIG. 8 shows the analog display when the upper-carriage 14 or the slewing platform of the mobile crane is rotated by 180° (see symbol image top left). The upper-carriage 14 is rotated towards the rear of the under-carriage 12. The fifth steering program is still set and all wheel axles 13 are steered. The left master switch 50 continues to steer the rear axle(s). However, these are at the front in the viewing direction of the driver sitting in the upper-carriage driver's cab 16 (i.e. the driver is looking towards the rear of the under-carriage 12). The changed steering angle, i.e. automatically switched by the software, can be seen on the display panels 62. The reference to the steering angle is the driver's direction of view. When the left master switch 50 is turned to the right, the vehicle also steers to the right. Assignment of the right master switch 50 takes place in a similar way. This is also preferably implemented for the “forward acceleration” and “backwards acceleration” commands.

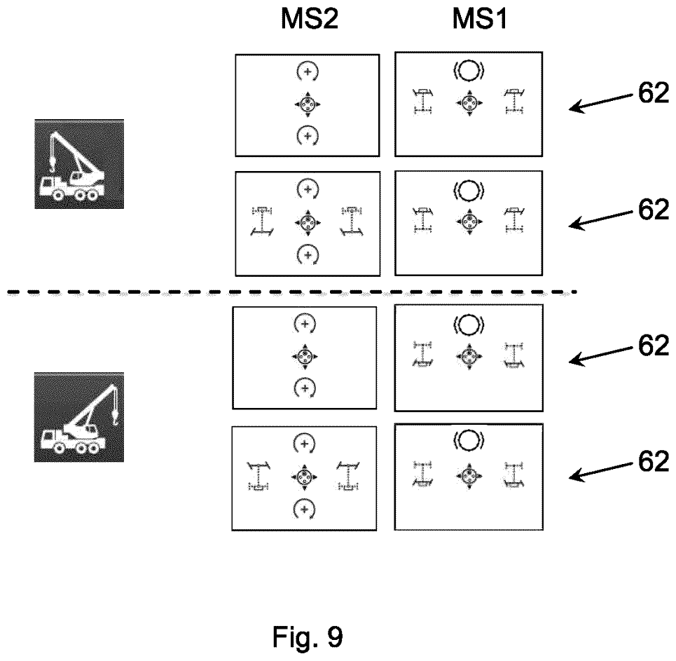

FIG. 9 shows a mapping of the representations to the various master switch assignments depending on the rotational position of the upper-carriage 14 (the latter can be recognized by the respective symbol images on the left; note the different position of the under-carriage driver's cab 15 on the symbol images). The left display panels 62 belong to the left master switch 50 (labeled “MS2” in FIG. 9) and the right display panels 62 belong to the right master switch 50 (designated “MS1” in FIG. 9).

### LIST OF REFERENCE CHARACTERS

10 Mobile crane
12 Under-carriage
13 Wheel axle
14 Upper-carriage
15 Under-carriage driver's cab
16 Upper-carriage driver's cab
18 Boom
20 Brake device (disk brake)
22 Brake device with parking brake
30 Drive motor
32 Transmission
34 Transfer case
36 Drive shaft
40 Steering drive
42 Steering wheel
50 Master switch
52 Travel selector switch
60 Display unit
62 Display panel
70 Switch unit
72 Button

1. Mobile equipment, comprising a mobile under-carriage with at least two wheel axles, an upper-carriage which is rotatably mounted on an under-carriage and comprises an upper-carriage driver's cab in which at least one operating unit for operating a working function of the mobile equipment is arranged, a steering system for steering at least one steerable wheel axle and a brake system with brake devices for braking at least one wheel axle,
wherein
the brake system comprises a brake valve arranged in the under-carriage for setting a brake pressure for the brake devices, which is electrically connected to the at least one operating unit of the upper-carriage driver's cab and can be controlled via the latter for braking the under-carriage.

2. Mobile equipment according to claim 1, wherein there is no accelerator pedal and/or no brake pedal in the upper-carriage driver's cab, but acceleration and/or braking of the under-carriage can be carried out exclusively via the at least one operating unit of the upper-carriage driver's cab.

3. Mobile equipment according to claim 1, wherein the brake system does not comprise any hydraulic or pneumatic connection between the under-carriage and the upper-carriage.

4. Mobile equipment according to claim 1, wherein the at least one operating unit is a master switch.

5. Mobile equipment according to the claim 1, wherein two master switches are provided in the upper-carriage driver's cab, wherein a speed and/or acceleration of the under-carriage can be controlled by actuating a first master switch and braking of the under-carriage can be controlled by actuating a second master switch.

6. Mobile equipment according to claim 1, wherein the under-carriage comprises a drive motor which is electrically connected to the at least one operating unit and can be controlled via the latter to control a traveling speed of the under-carriage.

7. Mobile equipment according to claim 1, wherein the steering system comprises a steering drive which is arranged in the under-carriage, is electrically connected to the at least one operating unit and can be actuated via the latter for controlling the steering of at least one steerable wheel axle.

8. Mobile equipment according to claim 5, wherein the brake valve is electrically connected to a control unit, which in turn is electrically connected to at least one receiving unit and is configured to obtain wirelessly transmitted control signals from a mobile operating unit for remote-controlled actuation of the brake valve.

9. Mobile equipment according to the claim 8, wherein the control unit is electrically connected to a steering drive arranged in the under-carriage and/or to a drive motor arranged in the under-carriage and is configured to obtain wirelessly-transmitted control signals for controlling the drive motor and/or the steering drive via the at least one receiving unit.

10. Mobile equipment according to claim 1, comprising a drive motor arranged in the under-carriage for providing power for the working function of the mobile equipment, and a control unit which is configured to automatically adjust a rotational speed of the drive motor to a power requested by at least one actuator of the mobile equipment for performing the working function.

11. Mobile equipment according to claim 1, wherein a display unit is arranged in the upper-carriage driver's cab, on which a parameter relating to a current braking process and/or a current acceleration process of the under-carriage can be displayed, in particular graphically illustrated.

12. Mobile equipment according to claim 1, wherein a speed of the under-carriage can be controlled and/or the under-carriage can be steered via the at least one operating unit, wherein a control unit connected to the at least one operating unit is configured to adapt operating inputs required to achieve a specific speed adjustment and/or steering effect to a current position of the mobile equipment, in particular a current angle of rotation of the upper-carriage relative to the under-carriage.

13. Mobile equipment according to claim 1, wherein the under-carriage can be both braked and accelerated via a single operating unit, in particular a master switch.

14. Mobile equipment according to claim 1, wherein a gear for a forward travel or a reverse travel of the under-carriage can be selected by actuating an operating unit, in particular a master switch.

15. Mobile equipment according to claim 1, wherein the mobile equipment is a mobile crane.
